(19) United States
(12) Patent Application Publication
(10) Pub. No.: US 2010/0002342 A1
(43) Pub. Date: Jan. 7, 2010

(54) Stand-Alone Pump Shut-Off Controller

(76) Inventors: Kevin Carlson, Chino Hills, CA (US); Quang Minh Truong, Ontario, CA (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/351,166

(22) Filed: Jan. 9, 2009

Related U.S. Application Data
(60) Provisional application No. 61/010,506, filed on Jan. 9, 2008.

(51) Int. Cl. H02H 7/085

(52) U.S. Cl. 361/31

(57) ABSTRACT

Embodiments of the invention provide a stand-alone controller and a method for controlling a pump motor driven by an alternating current source. The stand-alone controller includes a power terminal for connection with the alternating current source and a load terminal for connection with the pump motor. The stand-alone controller further includes an enable switch to form a power line carrying power from the alternating current source to the pump motor. The stand-alone controller can store a first current being drawn through the power line by the pump motor when a control switch is actuated. A state of the enable switch is based on a comparison of the first current to a second current being drawn through the power line by the pump motor.

This application claims priority under 35 U.S.C. § 119 to U.S. Provisional Patent Application No. 61/010,506 filed on Jan. 9, 2008, the entire contents of which is incorporated herein by reference.

### BACKGROUND

Many pump applications include some type of controller to control turning the pump on and off. The use of a controller can save energy by only operating the pump when needed. In addition, some controllers can also protect the pump motor by preventing the pump from running in a dry or clogged condition.

Some conventional pump controllers include mechanical float switches or flow meters to detect when the pump may be running in a dry condition or is clogged. Conventional controllers are often installed with connections to the pump itself and within the reservoir containing fluid to be pumped. In addition, further construction may be required to install the float switches or flow meters. Because of the multiple connections, controllers are often manufactured as part of a single pump or designed to be used with only one kind of pump or application (e.g., sump pump applications). Thus, most conventional controllers cannot be used on multiple pumps or for multiple applications.

### SUMMARY

Some embodiments of the invention provide a stand-alone controller for controlling a pump motor driven by an alternating current source. The controller includes a power terminal for removable connection with the alternating current source and a load terminal for removable connection with the pump motor. The controller also includes an enable switch selectively connecting the alternating current source to the load terminal in order to form a power line carrying power from the alternating current source to the pump motor. The controller further includes a control switch which can signal the controller to store a first current being drawn through the power line by the pump motor. A state of the enable switch is based on a comparison of the first current to a second current being drawn through the power line by the pump motor.

### DESCRIPTION OF THE DRAWINGS

FIG. 1 is a perspective view of a stand-alone pump shut-off controller according to one embodiment of the invention.

FIG. 2 is a flow chart of a method of operating the controller of FIG. 1.

FIG. 3 is a schematic of a control circuit for use with the controller of FIG. 1.

FIG. 4 is a schematic of a power circuit included in the control circuit of FIG. 3.

FIG. 5 is a schematic of a microcontroller circuit included in the control circuit of FIG. 3.

FIG. 6 is a schematic of a programming circuit included in the control circuit of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings, whether mechanical or electrical. Further, “connected” and “coupled” are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

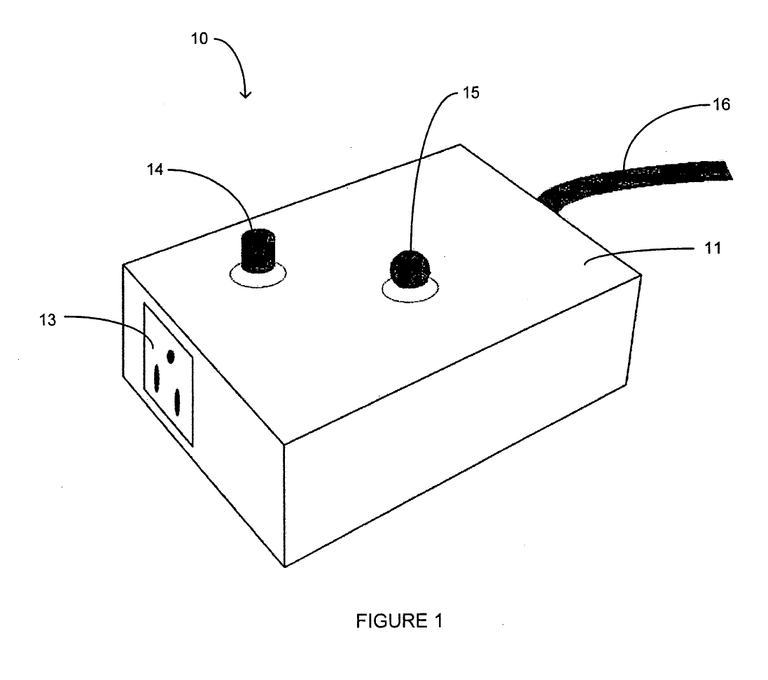

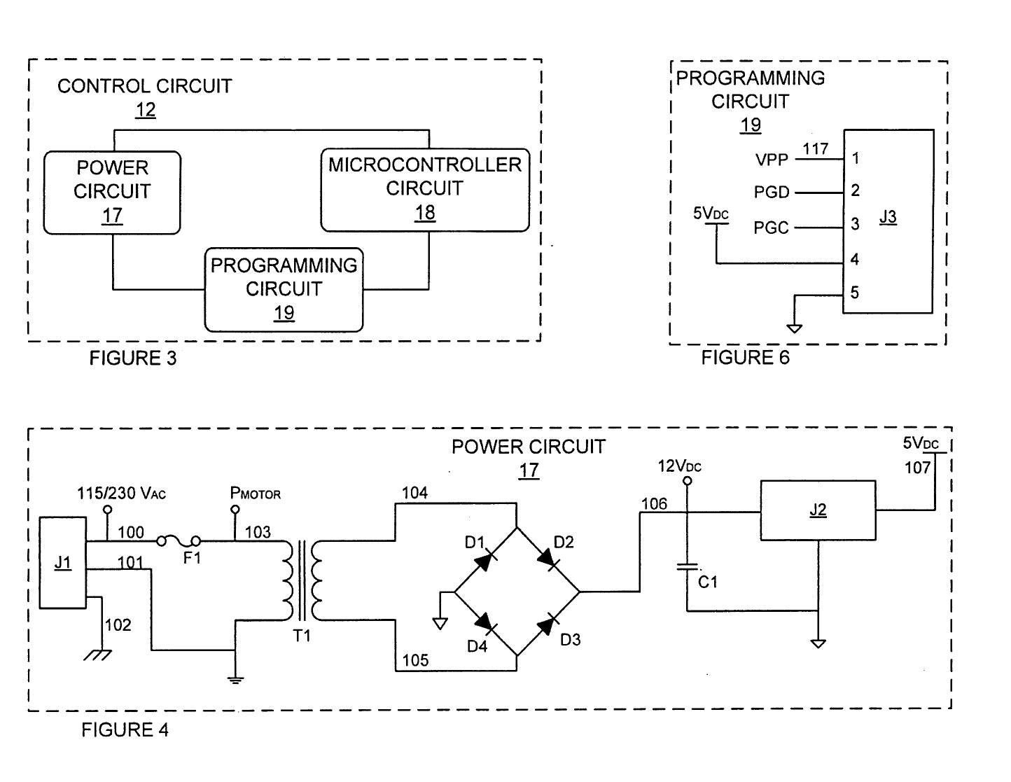

FIG. 1 illustrates a controller 10 for a pump according to one embodiment of the invention. The controller 10 can include a stand-alone controller box II and can be used in conjunction with any suitable pump. The controller box 11 can include a control circuit 12 (as shown in FIGS. 3-6), a plug outlet 13 (i.e., a female electrical connector or load terminal), a control switch 14, an indicator 15 (such as a light-emitting diode, LED), a power cord 16, and a power plug (i.e., a male electrical connector or power terminal, not shown). The pump can be plugged into the plug outlet 13 of the controller box 11. The power plug of the controller box 11 can be plugged into a power source (such as a wall outlet or AC outlet). In some embodiments, the power plug can be plugged into 110-230 volts AC and the plug outlet 13 can provide about 12 volts AC to about 230 volts AC and up to about 2 amps.

The pump can be plugged into the plug outlet 13 and the power plug can be plugged into the power source, causing the pump and the indicator 15 to turn on. The indicator 15 can indicate pump conditions to a user. For example, the indicator 15 can be on solid when the controller 10 is on and the pump is running normal. The indicator 15 can be flashing when the pump has run outside a threshold, reaching a shut-off condition. The indicator 15 can be off when no power is provided to the controller 10. The control switch 14 can be a tact switch, in some embodiments, and can be used to acquire a pump motor current when the pump is running. For example, if the control switch 14 is pressed and held down for a pre-selected time period (e.g., five seconds), a data collection period starts in which the control circuit 12 can read and store a current being drawn by the motor of the pump relating to a current condition (i.e., the shut-off condition) of the pump. The control circuit 12 can then use that current as the limit or threshold to later detect when the pump is running at the shut-off condition. In some embodiments, the shut-off condition can be set by the user before the power plug is plugged into the power source. In other embodiments, the shut-off condition can be set by the user after the power plug is plugged into the power source.

The control circuit 12 can be used to set the shut-off condition for which the control circuit 12 will stop providing power to the pump. In one example, the control circuit 12 can be set to stop providing power to the pump when a dry-running condition occurs (i.e., a no-load condition). The pump can be plugged into the controller box 11 and the pump can be started in a no-load or dry-running condition. To set this condition, the pump head can be disconnected from the plumbing system. While running in the no-load condition, the user can press the control switch 14 for a time period (e.g., five seconds) starting the data collection period and causing the control circuit 12 to take a current reading. The no-load current reading can be stored in memory in the control circuit 12 as the shut-off condition. Once the control circuit 12 has stored the no-load current, the pump can be operated with a load. If the current being drawn by the pump reaches the stored no-load current reading, indicating a shut-off condition, the indicator 15 can flash and the control circuit 12 can stop providing power to the pump.

In another example, the control circuit 12 can be set to stop providing power to the pump when a pre-selected pressure condition occurs (e.g., low pressure or high pressure, such as when the pump is running low or is clogged). The pump can be plugged into the controller box 11 and the pump can be started and operated at a particular pressure that the user wants as the lowest or highest operating pressure (i.e., the threshold pressure at which the user wants the pump to be shut down). Once the particular pressure is reached, the user can press the control switch 14 to signal the data collection period and the control circuit 12 can take a current reading for that threshold pressure. The current reading can be stored in memory in the control circuit 12 as the threshold current indicating the shut-off condition. Once the control circuit 12 has stored the threshold current, the pump can be operated normally. If the current being drawn by the pump motor reaches the threshold current reading (i.e., when the pressure reaches the threshold pressure, indicating the shut-off condition), the indicator 15 can flash and the control circuit 12 can stop providing power to the pump.

The control switch 14 can also be used to reset the controller 10. For example, if the indicator 15 is flashing because the control circuit 12 had detected a shut-off condition, the user can make adjustments to the pump so the shut-off condition is no longer occurring and press the control switch 14 to reset the controller 10 so the pump can turn on again.

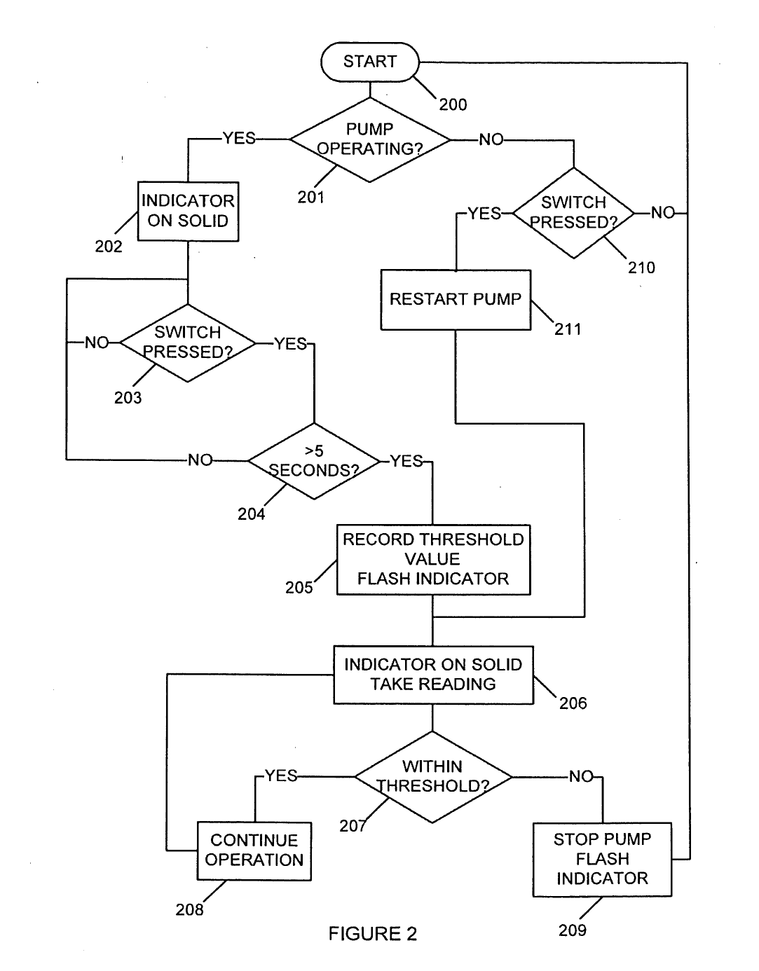

In some embodiments, the control circuit 12 can operate according to the method shown in FIG. 2. Once the pump is plugged into the controller 10 and the power plug is connected to the power source, the control circuit 12 proceeds to the start operation (task 200). From the start operation (task 200), the control circuit 12 determines if the pump is operating (task 201). If the pump is operating, the control circuit 12 turns on the indicator 15, if it is not already on (task 202), and substantially continuously determines if a user is actuating the control switch 14 (task 203). If the control switch 14 has been actuated, the control circuit 12 determines how long the control switch 14 is actuated (task 204). If the control switch 14 is actuated for longer than a specific time period (e.g., five seconds), indicating a desired data collection period, the control circuit 12 can read and store the current being drawn by the pump motor as a current threshold value and can flash the indicator 15 for a time period (task 205). This may occur when the user is running the pump in a desired shut-off condition, such as a no-load, high-pressure, or low-pressure condition. While the indicator 15 is still flashing, the user can start running the pump in normal operation. The control circuit 12 then turns the indicator 15 on solid again. Once the indicator is on solid again, the control circuit 12 substantially continuously determines the current being drawn by the pump motor and can compare it to the current threshold value (tasks 206-208). If the current being drawn by the pump is above the current threshold value (e.g., if the shut-off condition has occurred), the control circuit 15 can shut off the pump and can flash the indicator 15 (task 209), before returning back to the start operation (task 200).

In addition, the control circuit 12 can repeat tasks 206-208. If the control switch 14 has again been actuated for the time period, the control circuit 12 can revert back to task 205 and record and store a new current threshold value. The control circuit 12 can then continue to tasks 206-207 using the new current threshold value.

The user can know if the control switch 14 has been actuated long enough to signal the collection period (i.e., that the control circuit 12 has recorded the current) by making sure the indicator 15 is flashing. If the control circuit 12 detects that the control switch 14 has not been actuated for the time period at task 204, the control circuit 12 can return back to task 203, and the indicator 15 will not have flashed.

If the control circuit 12 detects that the pump is not operating at task 201 (e.g., the pump has been turned off because of a shut-off condition), the control circuit 12 can substantially continuously determine if a user is actuating the control switch 14 (task 210). If the user is actuating the control switch 14, the control circuit 12 turns on the pump and the indicator 15 (i.e., in a non-flashing mode) at task 211 and returns to task 206. Tasks 210 and 211 can occur when the user resets the device 10 after fixing the shut-off condition.

The controller 10 can automatically revert to the start operation (task 200) whenever a pump is plugged in or the controller 10 is plugged into a power source. The controller 10 can be used with different pumps and can be reset at any time after receiving power from a power source. It is easy to use the controller 10 with different pumps as there is only one connection between the pump and the controller 10 and no part of the controller 10 needs to be in contact with fluid that is being pumped. In addition, the controller 10 can be positioned any distance away from the pump as long as the plug of the pump can reach the plug outlet 13 of the controller 10. This can allow easy installation and easy access for the user.

In one embodiment, the control circuit 12 can include a power circuit 17, a microcontroller circuit 18, and a programming circuit 19, as shown in FIG. 3. The power circuit 17, as shown in FIG. 4, can include an internal fuse Fl for catastrophic failure. The power circuit 17 can also include the following: a transformer T1, such as Part No. 3FD-212, manufactured by Tamura Corporation, or similar; a rectifier D1-D4, such as Part No. DB101, manufactured by Diodes, Inc., among others; a capacitor C1 (e.g., 330 micro-farads); and a regulator J2 (e.g., a 5-volt, 1-amp positive voltage regulator), such as Part No. MC7805, manufactured by Fairchild Semiconductors®, among others. A connector J1 can represent electrical connections from the power plug. The power plug can be a conventional polarized plug with a hot connection 100, a neutral connection 101, and a ground connection 102. The fuse F1 can be placed between the connection 100 and a connection 103 to the transformer T1. The transformer T1 can also be connected to the connection 101 and ground. The transformer T1 can further be connected to the rectifier D1-D4 via connections 104 and 105. The rectifier D1-D4 can be connected to the regulator J2 via a connection 106. An output (connection 107) of the regulator J2 can be an isolated low-voltage node (e.g., five volts, direct-current) to power parts of the microcontroller circuit 18 and the programming circuit 19. In addition, the controller box 11 can be opened for maintenance if the fuse F1 or other components need to be replaced.

In some embodiments, different power circuits 17 can be adapted for different power source voltages. For example, different controllers 10 can be provided for the following power source voltages: 12, 24, 36, 100, 115, and 230 volts AC or volts DC, among others.

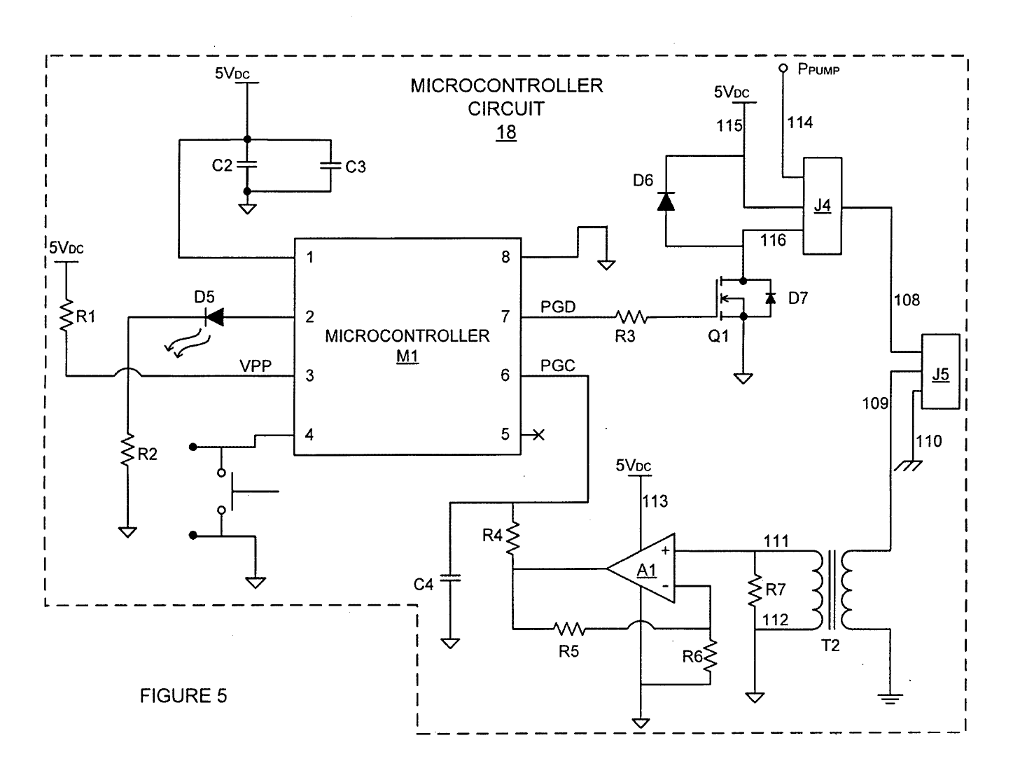

As shown in FIG. 5, the microcontroller circuit 18 can include a microcontroller chip M1 (e.g., Part No. PIC12F675, manufactured by Microchip Technology, Inc.) to control all operations of the controller 10 and provide memory to store the threshold current. The microcontroller chip M1 can be powered by the output of the regulator J2 (from the connection 107 shown in FIG. 4) at pin 1. The microcontroller circuit 18 can also include capacitors C2 and C3 for transient protection at pin 1. Pin 2 of the microcontroller chip M1 can be dedicated to the indicator 15, which can include an LED D5 connected in series connection with a resistor R2 (e.g., 560 ohms) and ground. Pin 4 of the microcontroller chip M1 can be dedicated to the control switch 14, which can be a tact switch in some embodiments. Pin 5 of the microcontroller chip M1 can be open. Pin 6 of the microcontroller chip Ml can be dedicated to an amplifier A1 and a transformer T2 in connection with a connector J5. The connector J5 can represent electrical connections from the plug outlet 13. The plug outlet 13 can be a conventional polarized outlet with a hot connection 108, a neutral connection 109, and a ground connection 110 and can receive a plug of the pump. When the pump is plugged into the plug outlet 13, the transformer T2 is in electrical connection with the pump via the connection 109.

The transformer T2 can be a current-sense transformer to read the AC current being drawn by the pump motor and also provide voltage isolation between the pump and the microcontroller chip M1. The transformer T2 can include a parallel connection with a resistor R7 (e.g., 60 ohms) between connections 111 and 112 and the connection 112 can further be connected to ground. The amplifier A1 (e.g., an LM358 operational amplifier, manufactured by National Semiconductor, among others) can amplify the current signal from the transformer T2 at the connection 111. For proper amplification and transient protection, the amplifier A1 can be in connection with resistors R4 (e.g., 10 kilo-ohms), R5 (e.g., 22 kilo-ohms), and R6 (e.g., 1 kilo-ohm) and a capacitor C4 (e.g., 22 micro-farads). The amplifier A1 can be powered by the output or the regulator J2 (from the connection 107) at a connection 113.

Pin 7 of the microcontroller chip Ml can be dedicated to controlling power to the pump motor (P_{PUMP}) at the connection 108 via an enable switch, such as a relay J4. The power to the pump motor, P_{PUMP}, can be connected to the relay J4 via a connection 114 and can come from the connection 103 of the power circuit 17. The relay J4 can be powered by the output of the regulator J2 (from the connection 107) at a connection 115. A control command from pin 7 of the microcontroller chip Ml can be received by the relay J4 at a connection 116. A MOSFET Q1 (such as Part No. 2n7000, manufactured by National Semiconductors®, among others), a diode D7, and a resistor R3 (e.g., 60 ohms) can be included between pin 7 and the connection 116. A diode D6 (such as Part No. 1n4001, manufactured by Fairchild Semiconductor®) can be positioned to prevent voltage powering the relay from controlling the power to the pump (P_{PUMP}). Pin 8 of the microcontroller chip Ml can be connected to ground for reference.

The controller box 11 can be opened to expose the control circuit 12 for maintenance or access to the programming circuit. The programming circuit, as shown in FIG. 6, can include a programming port J3 for reprogramming the microcontroller chip M1. During normal operation (i.e., not during reprogramming), the microcontroller chip M1 can be powered by the output of the regulator J2 (from the connection 107, as shown in FIG. 4). During reprogramming, power can be removed from the controller 10, and the output from the regulator J2 will no longer be supplied to power the microcontroller chip M1. In this case, the operating voltage needed (e.g., 5 volts) can be supplied to the microcontroller chip M1 by the programming port J3 from pin 4. A higher voltage, V_{PP}, can also be supplied from the programming port J3 from a connection 117 (at pin 1 of J3) to pin 3 of the microcontroller chip M1 to put the microcontroller chip M1 into a programming mode. Pins 2 and 3 of the programming port J3 (labeled PGD and PGC, respectively) can also be connected to pins 7 and 6, respectively, of the microcontroller chip M1 to synchronize clocks and send and receive data. Pin 5 of the programming port J3 can be connected to ground for reference. The microcontroller chip M1 can be reprogrammed to adjust parameters such as the time period needed to actuate the control switch 14 to signal the data collection period, whether above or below the threshold current indicates a shut-off condition, or other parameters.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A stand-alone controller for controlling a pump motor driven by an alternating current source, the controller comprising:
a power terminal for removable connection with the alternating current source;
a load terminal for removable connection with the pump motor;
an enable switch selectively connecting the alternating current source to the load terminal in order to form a power line carrying power from the alternating current source to the pump motor; and
a control switch signaling a data collection period when the control switch is one of open and closed for a first time interval, the data collection period being when the controller stores a first current being drawn through the power line by the pump motor, a state of the enable switch being based on a second current being drawn through the power line by the pump motor in comparison to the first current.

2. The controller of claim 1 and further comprising the control switch signaling a restart period when the control switch is one of open and closed for a second time interval and the state of the enable switch being based on the restart period.

3. The controller of claim 1 and further comprising an LED, where the state of the LED is based on the state of the enable switch.

4. The controller of claim 3, where the state of the LED is further based on the collection period.

5. The controller of claim 1 wherein the first time interval is about five seconds.

6. The controller of claim 1 wherein the state of the enable switch includes being one of closed and open.

7. The controller of claim 5 wherein the state of the enable switch is open when the second current is greater than or equal to the first current and is closed when the second current is less than the first current.

8. The controller of claim 1 wherein the enable switch is a relay switch.

9. The controller of claim 1 and further comprising a programming port.

10. The controller of claim 1 and further comprising a microcontroller, the microcontroller reading when the control switch is one of open and closed, storing the first current, comparing the first current and the second current, and controlling the state of the enable switch.

11. The controller of claim 1 wherein the power terminal is a polarized plug with a hot connection, a neutral connection, and a ground connection.

12. The controller of claim 1 wherein the load terminal is a polarized plug outlet with a hot connection, a neutral connection, and a ground connection.

13. The controller of claim 1 and further comprising a current sense transformer sensing the first current and the second current being drawn by the pump motor.

14. A method for controlling a pump motor driven by an alternating current source, the method comprising:
providing a stand-alone controller;
connecting a power plug of the stand-alone controller to the alternating current source;
connecting the pump motor to a plug terminal of the stand-alone controller;
providing an enable switch in the stand-alone controller selectively connecting the alternating current source to the pump motor in order to form a power line carrying power from the alternating current source to the pump motor;
actuating a control switch on the stand-alone controller to store a first current being drawn through the power line by the pump motor;
comparing a second current being drawn through the power line by the pump motor to the first current; and
operating the enable switch to be in one of an open and closed position based on the comparison of the second current and the first current.

15. The method or claim 14 and further comprising providing an LED on the stand-alone controller to indicate the position of the enable switch.

16. The method of claim 14 wherein the enable switch is in the open position when the second current is greater than or equal to the first current.

17. The method of claim 14 wherein the enable switch is in the closed position when the second current is less than the first current.

18. The method of claim 14 and further comprising operating the enable switch to be in one of the open and close position to prevent the pump motor from operating in a dry-running condition.

19. The method of claim 14 and further comprising actuating the control switch on the stand-alone controller to store a first current being drawn through the power line by the pump motor during at least one of a dry-running condition, a clogged condition, a high-pressure condition, and a low-pressure condition.

20. The method of claim 14 and further comprising actuating the control switch on the stand-alone controller for at least about five seconds to store the first current being drawn through the power line by the pump motor.
